(19) United States
(12) Patent Application Publication
(10) Pub. No.: US 2006/0022987 A1
(43) Pub. Date: Feb. 2, 2006

(54) Method and apparatus for arranging block-interleaved image data for efficient access

(76) Inventors: Barinder Singh Rai, Surrey (CA); Eric Jeffrey, Richmond (CA)

Correspondence Address: EPSON RESEARCH AND DEVELOPMENT INC;INTELLECTUAL PROPERTY DEPT, 150 RIVER OAKS PARKWAY, SUITE 225, SAN JOSE, CA, 95134, US

(21) Appl. No.: 10/902,541

(22) Filed: Jul. 29, 2004

(51) Int. Cl. G06F 12/00; G06F 12/06

(52) U.S. Cl. 345/564; 345/571

(57) ABSTRACT

The invention is directed to specifying addresses in a memory for each sample in a minimum coded unit. Preferably, the samples are presented in a predetermined sequence to the memory for storage. For each sample, its presentation to the memory is detected and an offset parameter is provided. Addresses are specified by adding the offset parameter to a base address. When addresses are created for all of the samples that define a particular pixel, all of the addresses are for locations in a particular row of the memory. This allows the samples that define a pixel to be read in one or two read operations.

### FIELD OF THE INVENTION

The present invention relates generally digital image processing, and particularly to a method and apparatus for arranging block-interleaved image data in memory for efficient access.

### BACKGROUND

The term “computer system” today applies to a wide variety of devices. The term includes mainframe and personal computers, as well as battery-powered computer systems, such as personal digital assistants and cellular telephones. In computer systems, a graphics controller is commonly employed to couple a CPU to a display device, such as a CRT or an LCD. The graphics controller performs certain special purpose functions related to processing image data for display so that the CPU is not required to perform such functions. For example, the graphics controller may include circuitry for decompressing image data as well as an embedded memory for storing it.

Display devices receive image data arranged in raster sequence and render it in a viewable form. An image is formed from an array, often referred to as a frame, of small discrete elements known as “pixels.” The term, however, has another meaning; pixel refers to the elements of image data used to define a displayed pixel's attributes, such as its brightness and color. For example, in a digital color image, pixels are commonly comprised of 8-bit component triplets, which together form a 24-bit word that defines the pixel in terms of a particular color model. A color model is a method for specifying individual colors within a specific gamut of colors and is defined in terms of a three-dimensional Cartesian coordinate system (x, y, z). The RGB model is commonly used to define the gamut of colors that can be displayed on an LCD or CRT. In the RGB model, each primary color—red, green, and blue—represents an axis, and particular values along each axis are added together to produce the desired color. Similarly, pixels in display devices have three elements, each for producing one primary color, and particular values for each component are combined to produce a displayed pixel having the desired color.

Image data requires considerable storage and transmission capacity. For example, consider a single 512×512 color image comprised of 24-bit pixels. The image requires 786 K bytes of memory and, at a transmission rate of 128 K bits/second, 49 seconds for transmission. While it is true that memory has become relatively inexpensive and high data transmission rates more common, the demand for image storage capacity and transmission bandwidth continues to grow apace. Further, larger memories and faster processors increase energy demands on the limited resources of battery-powered computer systems. One solution to this problem is to compress the image data before storing or transmitting it. The Joint Photographic Experts Group (JPEG) has developed a popular method for compressing still images. Compressing the 512×512 color image into a JPEG file creates a file that may be only 40-80 K bytes in size (depending on the compression rate and the properties of the particular image) without creating visible defects in the image when it is displayed.

The JPEG standard employs a forward discrete cosine transform (DCT) as one step in the compression (or coding) process and an inverse DCT as part of the decoding process. Before JPEG coding, the pixels that define a source image are commonly converted from the RGB color model to a YUV model. In addition, the source image is separated into component images, that is, Y, U, and V images. In an image, pixels and pixel components are distributed at equally spaced intervals. Just as an audio signal may be sampled at equally spaced time intervals and represented in a graph of amplitude versus time, pixel components may be viewed as samples of a visual signal, such as brightness, and plotted in a graph of amplitude versus distance. The audio signal has a time frequency, whereas the visual signal has a spatial frequency. Moreover, just as the audio signal can be mapped from the time domain to the frequency domain using a Fourier transform, the visual signal may be mapped from the spatial domain to the frequency domain using the forward DCT. The human auditory system is often unable to perceive certain frequency components of an audio signal. Similarly, the human visual system is frequently unable to perceive certain frequency components of a visual signal. The data needed to represent unperceivable components may be discarded allowing the quantity of data to be reduced.

According to the JPEG standard, the smallest group of data units coded in the DCT is a minimum coded unit (MCU). The MCU is comprised of a number of blocks. A “block” is an 8×8 array of “samples.” A sample is one element in a two-dimensional array that describes a component image. A component image is an image comprised of a single type of component. A user defined “sampling format” (described in greater detail below) is specified for the source image. The sampling format may be specified so that every sample in a component image is selected for JPEG compression. In this case, the MCU comprises three blocks, one for each component. Commonly, however, the sampling format is specified so that every sample in the Y component image is selected, but only 50% or 25% of the samples in the U and V component images are selected. In the latter cases, the MCU comprises four blocks and six blocks, respectively. The blocks for each MCU are grouped together in an ordered sequence, e.g., Y₀U₀V₀, the subscript denoting the block. The MCUs are arranged in an alternating or “interleaved” sequence before being compressed, and this type of data ordering is referred to here as “block-interleaved.”

When a JPEG file is received, it is normally decoded by a special purpose block of logic known as a CODEC (compressor/decompressor). The output from the decoding process is block-interleaved image data. As the CODEC is adapted to work in many different computer systems, it is not designed to output image data in any format other than the block-interleaved format. Display devices, however, are not adapted to receive block-interleaved image data; rather display devices expect pixels arranged in raster sequence. Moreover, operations performed by the graphics controller are commonly adapted to be performed on raster ordered pixels. (A raster sequence begins with the left-most pixel on the top line of the array, proceeds pixel-by-pixel from left to right, and when the end of the top line is reached proceeds to the second line, again beginning with the left-most pixel, and continues to each successively lower line until the end of the last line is reached.)

The block-interleaved image data output from the CODEC is normally stored in a memory as blocks. The CODEC may be adapted to generate addresses for storing each type of component together with other blocks of the same type. In order to obtain the image data needed for any particular pixel, it is necessary to fetch one sample from each of the three blocks stored in various parts of the memory. This means that each sample must be fetched separately. This is not a particularly serious limitation if the frame is small and stored in synchronous random access memory (SRAM). However, as frame size increases a dynamic random access memory (DRAM) is often substituted for the more expensive SRAM. Separately fetching samples from DRAM is a limitation of some significance. DRAM imposes a row pre-charge penalty each time memory in a different row is accessed. Separately fetching samples from DRAM consumes a substantial amount of memory bandwidth. In addition, separately fetching samples requires a significant amount of power. Because minimizing power consumption in battery-powered computer systems is critical, separately fetching image data is a significant problem in these devices.

Thus a method and apparatus capable of arranging JPEG decoded block-interleaved image data in memory for efficient access would provide significant benefits.

### BRIEF SUMMARY OF THE INVENTION

The invention is directed to an method and apparatus for specifying addresses in a memory for each sample in a minimum coded unit. The minimum coded unit defines a plurality of pixels. Each pixel is defined by a plurality of sample components. The memory has a plurality of memory locations, each of which is defined by a column and a row. Each memory location has an address. In a preferred context, samples are presented in a predetermined sequence to the memory for storage.

The method comprises detecting the presentation to the memory of the samples that define a particular pixel; providing an offset parameter for each of the samples, and storing the samples at an address. Each offset parameter is based on the respective position of the sample within the predetermined sequence. The offset parameters are added to a base address to yield addresses for locations in a particular row of the memory. The offset parameter for each of the samples yields respective addresses such that the samples that define a first pixel can be read in one or two read operations.

The apparatus comprises a detector for detecting the presentation to the memory of the samples that define a particular pixel and a sample arranger. The sample arranger provides an offset parameter for each of the samples. Each offset parameter is based on the respective position of the sample within the predetermined sequence. The sample arranger adds the offset parameters to a base address to yield addresses for locations in a particular row of the memory. The offset parameter for each of the samples yields respective addresses such that the samples that define a first pixel can be read in one or two read operations.

The objectives, features, and advantages of the invention will be more readily understood upon consideration of the following detailed description of the invention, taken in conjunction with the accompanying drawings.

### BRIEF DESCRIPTION OF THE SEVERAL VIEWS OF THE DRAWINGS

FIG. 1 is a block diagram of a computer system for decoding and displaying compressed image data, which is a preferred context for the invention.

FIGS. 2a-2c are diagrams that illustrate three exemplary methods for selecting samples from a component image.

FIGS. 3a-c show a group of source image pixels, component samples selected from the group according to a 4:2:2 sampling format, and the group of pixels that are reconstructed from the selected samples.

FIGS. 4a-4d are diagrams that illustrate a source image and blocks formed by selecting samples from the source image according to three exemplary sampling formats.

FIGS. 5a-5c are diagrams of a memory having blocks of samples stored therein, the blocks having been formed by selecting samples according to three exemplary horizontal sampling formats.

FIG. 6 is a diagram of a memory having blocks of samples stored therein.

FIG. 7 is a block diagram of a computer system for decoding and displaying compressed image data, which includes a sample arranger and a memory, according to the invention.

FIGS. 8a-c are diagrams of a portion of the memory of FIG. 7 having samples stored therein according to the invention.

FIGS. 9a-c are diagrams of a portion of the memory of FIG. 7 having samples stored therein according to the invention.

FIG. 10 is a block diagram of the sample arranger of FIG. 7, which includes a logic circuit.

FIGS. 11a-d are diagrams of state machines for defining the operation of the logic circuit of FIG. 10.

### DETAILED DESCRIPTION OF A PREFERRED EMBODIMENT

The invention is directed to a method and apparatus for arranging block-interleaved image data in memory for efficient access. Examples illustrating the context and the present preferred embodiments of the invention are illustrated in the accompanying drawings. Wherever possible, the same reference numbers are used in the drawings and the description to refer to the same or like parts.

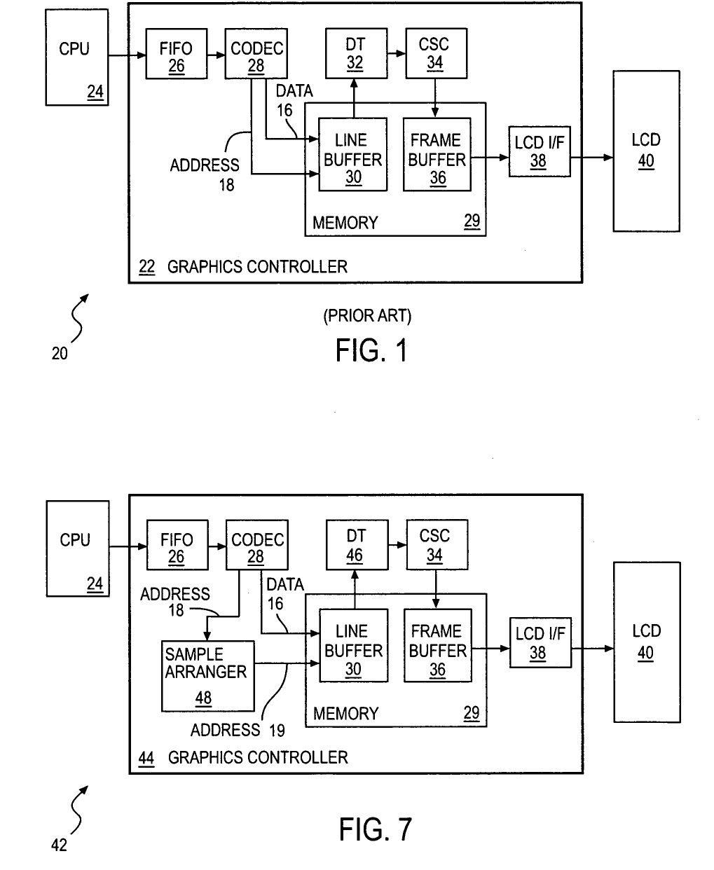

FIG. 1 illustrates a block diagram of a computer system 20 having a graphics controller 22 coupled to a CPU 24 and an LCD 40. FIG. 1 is but one preferred context for the invention. The graphics controller 22 includes a FIFO memory 26, used for buffering data received from the CPU 24, and a CODEC 28. In addition, the graphics controller 22 includes an embedded memory 29, part of which is set aside as a line buffer 30 and another part of which is set aside as a frame buffer 36. The memory 29 is preferably a DRAM. The graphics controller 22 also includes a dimensional transform circuit 32, a color space conversion circuit 34, and an LCD interface circuit 38.

FIG. 1 illustrates the path that image data takes as it is transformed from JPEG file format to raster ordered pixels ready for display. In operation, the CPU 24 writes a JPEG file to the FIFO 26. The CPU 24 is an illustrative device; the JPEG file may be written by another device, such as a camera, a network interface, a memory controller, or any other device with data transfer capabilities. The CODEC 28 accesses the FIFO 26, decompresses the JPEG file using an inverse DCT-based process, and writes decoded block-interleaved image data to the line buffer 30. The CODEC sends data to the memory 29 via bus 16 and specifies the address where the data is to be stored via bus 18. Alternatively, address and data information may be multiplexed on a single bus. The dimensional transform (DT) circuit 32 reads the image data in the line buffer 30, assembles the samples into pixels, and after performing any desired dimensional transform operations, such as cropping and scaling, and sends the pixels to the color space conversion (CSC) circuit 34. The color space conversion circuit 34 converts the pixel data into the RGB format and stores it in the frame buffer 36 in raster order. The LCD interface circuit 38 reads pixels from the frame buffer 36 and presents them to the LCD 40 for display. The LCD 40 is an illustrative display device; a CRT or any similar device for rendering image data for viewing may be substituted. In the computer system 20 of FIG. 1, the image data is stored in the line buffer 30 in the form of decoded block-interleaved image data. In addition, the dimensional transform circuit 32 requires a full row of pixels before it can begin its operation.

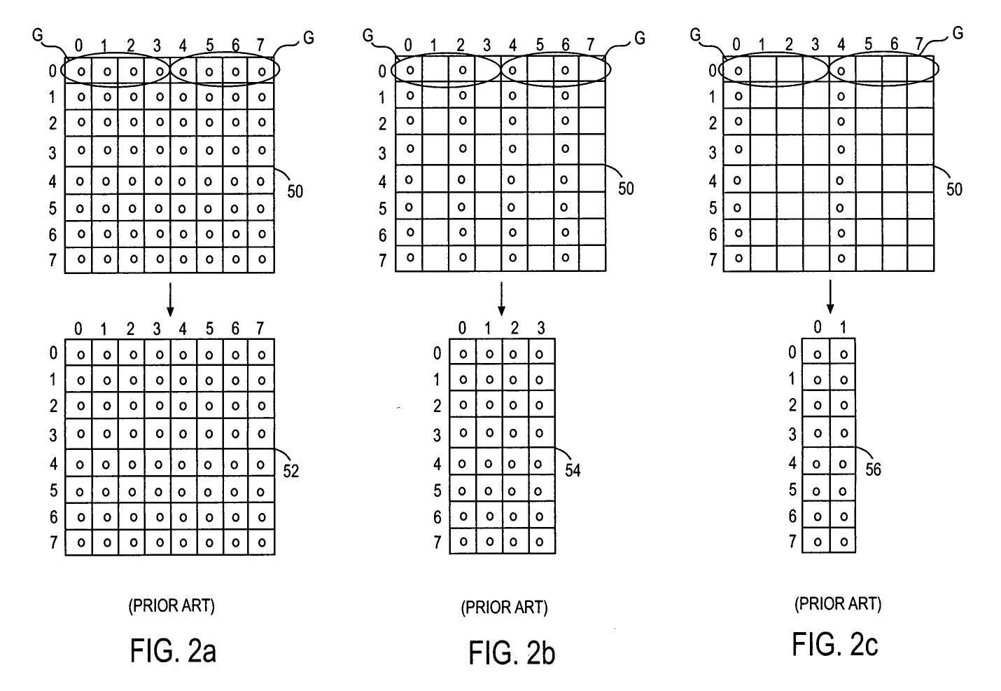

FIGS. 2a-2c depict blocks 50 of samples and show three exemplary schemes for selecting samples. A sample describes one component of a pixel. Each block 50 is an 8×8 matrix of samples of one component of a source image, i.e., block 50 may be the R, G, B, Y, U, V, or some other component of a source image. FIGS. 2a-2c show original blocks 50 before samples are selected, and collections of selected samples 52, 54, and 56 that result from exemplary sample selection schemes. The figures show, respectively, the selection of 100%, 50%, and 25% of the samples. In the figures, each sample is represented by a square, and a circle within the square indicates that the sample is selected. A square which does not have a circle within it is not selected. In each block 50, each row consists of two groups G of four consecutive samples. In FIG. 2a, all of the samples in each group G are selected. In FIG. 2b, the first and third samples in each group G are selected. And in FIG. 2c, only the first sample in each group is selected.

The phrase “sampling format” refers to the sample selection scheme and can be understood to refer to the number of samples selected in each group G. If all four pixels in each group G are selected, the sampling format is 4:4:4. If all of the samples in the Y block, but just 2 samples in each group G in the U and V blocks are selected, the sampling format is 4:2:2. In other words, for 4:2:2, samples from the Y block are selected as shown in FIG. 2a, but samples from the U and V blocks are selected as shown in FIG. 2b. If all of the samples in the Y block are selected, but just 1 sample in the U and V blocks is selected, the sampling format is 4:1:1. In other words, samples from the Y block are selected as shown in FIG. 2a, but samples from the U and V blocks are selected as shown in FIG. 2c. Other sampling formats are known and provide for selection of samples different from those described. For instance, some sampling formats define the group G to include 2 rows so that samples are selected vertically as well horizontally.

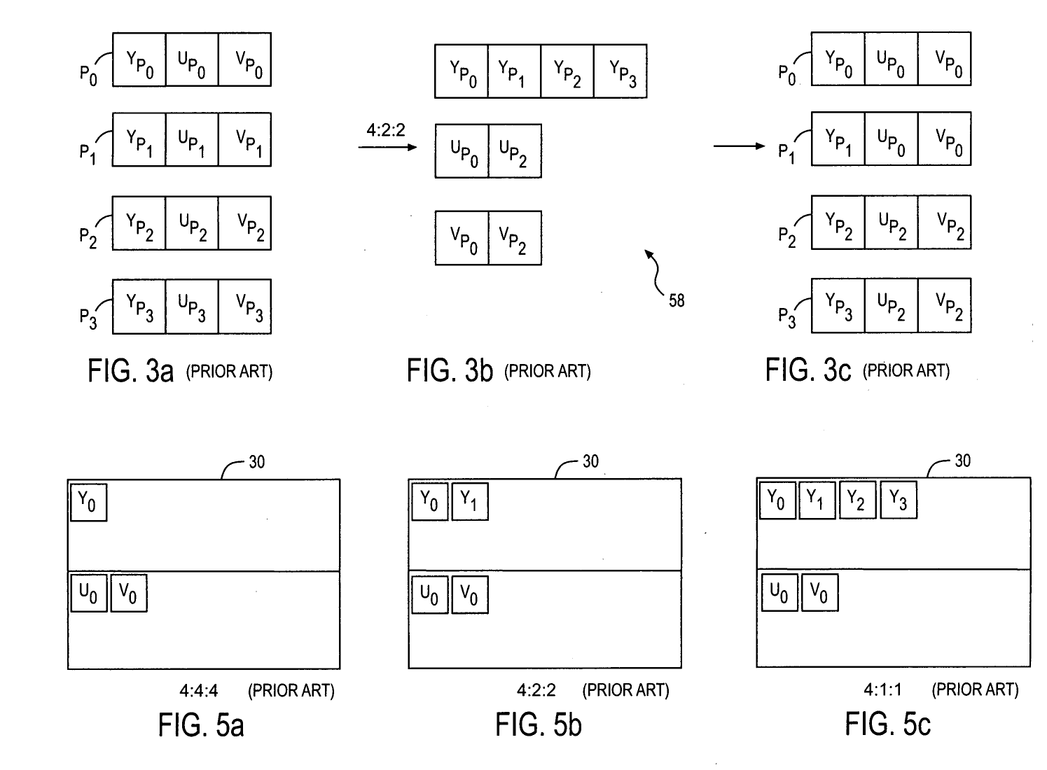

FIGS. 3a-c show an example of the 4:2:2 sampling format. FIG. 3a shows a group of source image pixels (P₀, P₁, P₂, P₃). FIG. 3b shows the component samples selected from the group according to a 4:2:2 sampling format. And FIG. 3c shows the group of pixels (P₀, P₁, P₂, P₃) as reconstructed from the selected samples. For instance, the reconstructed P₀ is defined by the very same components that defined the source image pixel. But the reconstructed P₁ is defined, in part, by (U and V) components that are not the same components that defined the source image pixel.

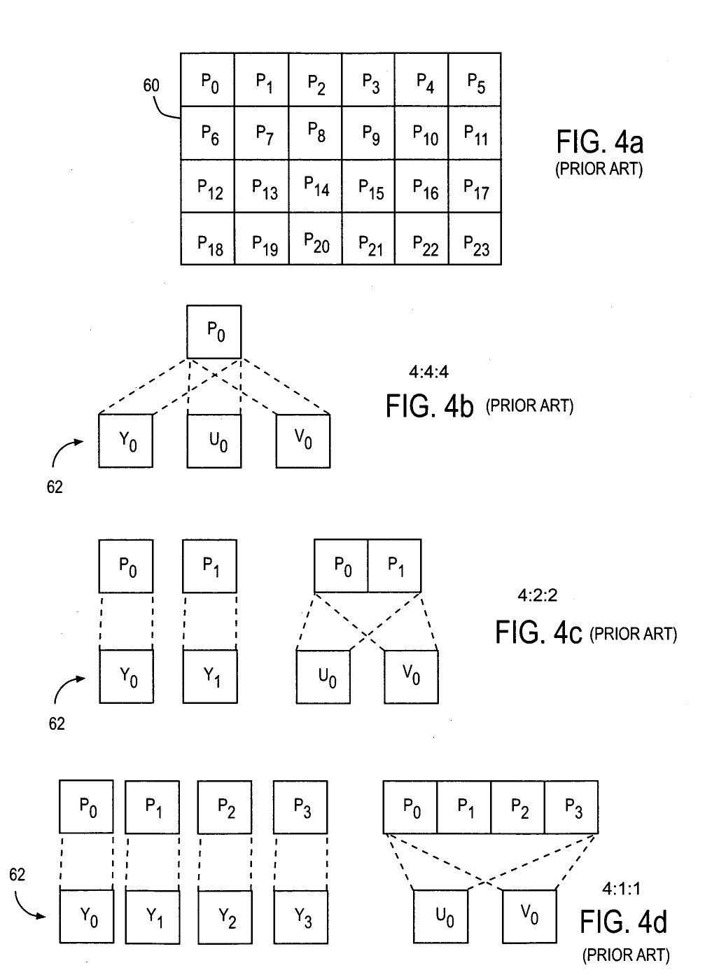

FIGS. 4a-d show the mapping of a source image 60 into component blocks 62. FIG. 4a shows source image 60. The image 60 comprises twenty-four 8×8 blocks of pixels P₀ to P₂₃. In FIG. 4b samples have been selected using a 4:4:4 sampling format. The component blocks Y₀, U₀, and V₀ are created from pixel block P₀ (as shown with dashed lines). In FIG. 4c samples have been selected using a 4:2:2 sampling format. The component blocks Y₀ and Y₁, are created, respectively, from pixel blocks P₀ and P₁. These pixel blocks also together create one 8×8 block of U samples and one 8×8 block of V samples, i.e., U₀ and V₀. In FIG. 4d, samples have been selected using a 4:1:1 sampling format. Four component blocks of Y are created from pixel blocks P₀ to P₃. But only one block each of U and V components are created from these four pixel blocks. The smallest group of data units coded in a forward DCT is an MCU. In these figures, the blocks 62 form an MCU for the specified sampling format.

In the computer system 20 of FIG. 1, the image data is stored in the line buffer 30 in the form of decoded block-interleaved image data. FIGS. 5a-5c illustrate, respectively, how the CODEC stores 4:4:4, 4:2:2, and 4:1:1 decoded block-interleaved image data in the line buffer 30. In the figures, the Y samples are stored in the first half of the line buffer 30, and the U and V blocks are stored in the second half. The figures show that the samples which form a particular pixel are not located in adjacent memory locations. To obtain any particular pixel, the dimensional transform circuit 32 must fetch samples from various locations of the memory 30. Thus three fetches from memory are generally required to fetch a pixel.

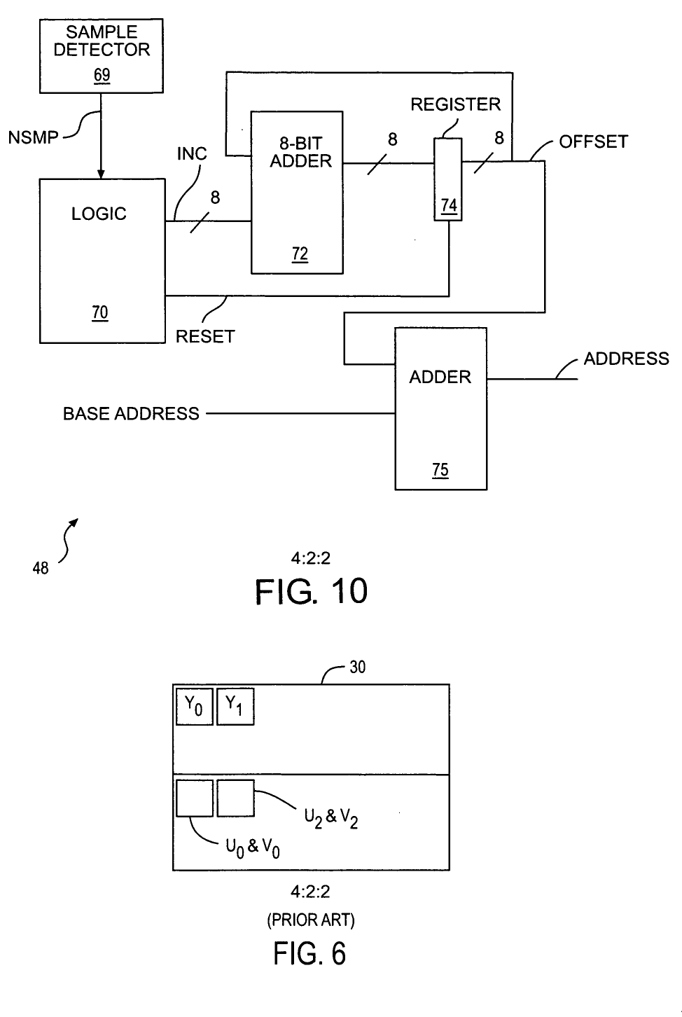

An alternative form of storage is shown in FIG. 6. As shown in FIG. 6, the CODEC may store the U and V blocks of 4:2:2 block-interleaved image data in memory as combined U and V blocks. Each combined block has 32 U samples and 32 V samples and the U and V samples are arranged in alternating order. A similar form of storage may be employed for 4:1:1 block-interleaved image data. At least two fetches from memory are still required to fetch a pixel.

Referring to FIG. 7, a block diagram of a computer system 42 having a graphics controller 44 according to one preferred embodiment of the invention is illustrated. The computer system 42 and graphics controller 44 are similar to those described with reference to FIG. 1, except that dimensional transform circuit 46 (DT) differs from dimensional transform circuit 32 (mainly in the way it fetches data from the line buffer 30) and graphics controller 44 includes a sample arranger 48.

Before describing operation of the sample arranger 48, the method by which locations in a DRAM are accessed and the problem that occurs when related elements of data are stored in distant locations is first reviewed. In addition, a preferred and exemplary efficient arrangement of image data in memory according to the invention is described. The data is arranged using addresses provided by the sample arranger 48. With the efficient arrangement of data in mind, the operation of the sample arranger 48 is then explained.

In a preferred embodiment, the memory 29 is a DRAM and one byte is stored at each address. In a DRAM, an address location is defined by a column and a row, and a single memory access requires 7 memory clock cycles (“MCLK”). A pre-charge is required each time a new row is accessed. When a DRAM is accessed, a row address is input to the DRAM and a row address strobe (RAS) is asserted. After a timing interval, a column address is input to the DRAM and a column address strobe (CAS) is asserted. If related elements of data are stored in distant locations, it takes 7 MCLKs to access each element. The problem is that it can take a large number of MCLKs to fetch needed data. In particular, it takes a substantial number of MCLKs to fetch the samples needed to assemble a pixel from decoded block-interleaved image data stored as blocks in the line buffer 30, such as that shown in FIGS. 5a-5c and 6.

If successive bytes can be read from or written to locations in the same row, however, the pre-charge is only required for the first access. Moreover, if successive bytes can read from locations in the same row, a new row address does not have to be sent and strobed in with the RAS signal. For these reasons, accessing successive bytes in the same row requires far fewer clock cycles. The invention enables successive bytes in the same row to be accessed, reducing the required number of clock cycles needed to read a pixel.

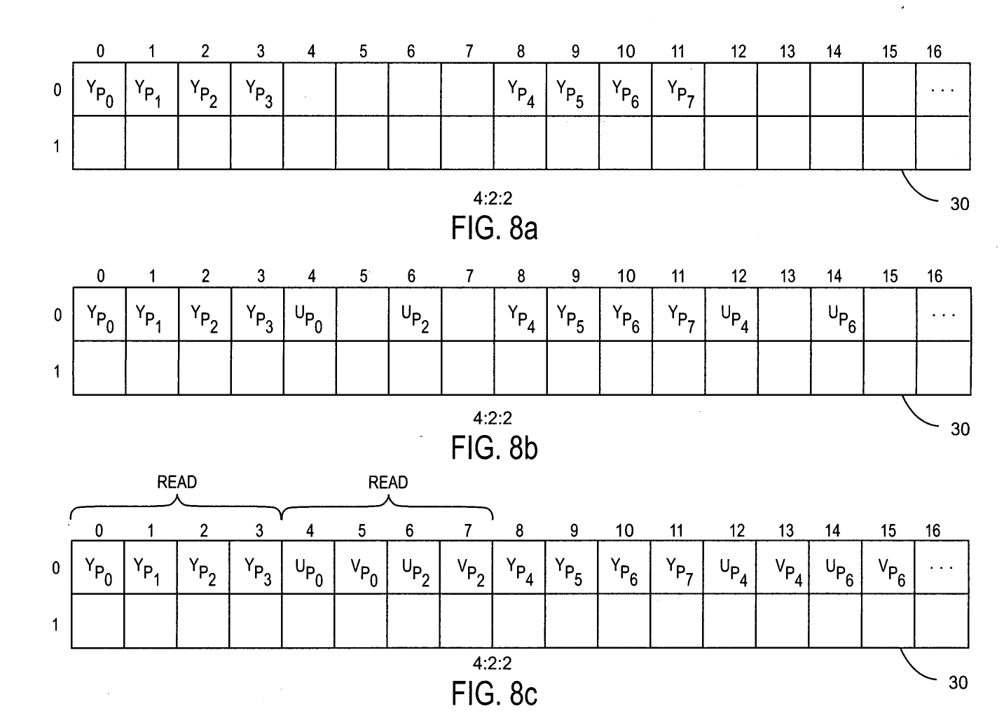

FIGS. 8a-c show samples stored in the line buffer 30 according to one preferred embodiment of the invention. In this example, the 4:2:2 sampling format is employed; thus there are 2 blocks of Y, 1 block of U, and 1 block of V in each MCU. Each figure shows only a portion of the line buffer 30: 2 rows and the first 16 columns. FIG. 8a shows the columns where the first 8 samples from the first Y block are stored:
(0, 1, 2, 3, 8, 9, 10, 11).
   Samples are stored in four sequential memory locations and then four memory locations are skipped. This pattern is repeated for the remainder of the first Y block as well as for the second Y block. The skipped locations are reserved for U and V samples. FIG. 8b shows the columns where the first 4 samples from the U block are stored:
(4, 6, 12, 14).
   And FIG. 8c shows the columns where the first 4 samples from the V block are stored:
(5, 7, 13, 15).

From FIG. 8c, it can be seen that the first 8 memory locations hold the samples needed to create reconstructed pixels P₀, P₁, P₂, P₃. In a read access, 4 bytes are typically read. A first read from row 0, will fetch the needed Y samples and a second read will fetch the needed U and V samples. Thus in two reads all of the samples components for four pixels may be fetched.

The first read operation, which reads the Y samples, requires 7 MCLKs. Because the U and V samples are stored in the same row, these samples can be read in only 1 additional MCLK. Thus all of the samples for 4 pixels can be read in just 8 MCLKs. In contrast, at least 14 MCLKs are required to read all of the samples if the U and V sample components are stored in a different row from the Y samples.

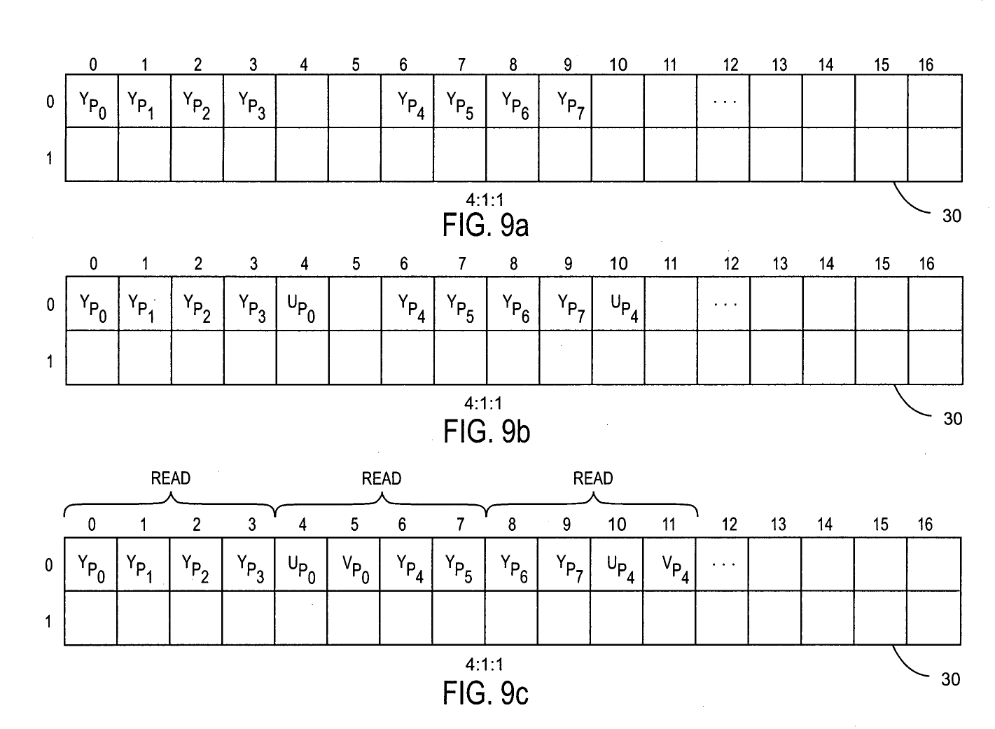

FIGS. 9a-c shows samples stored in the line buffer 30 according to a preferred embodiment of the invention. In this example, the 4:1:1 sampling format is employed. FIG. 9a shows the columns where the first 8 samples from the first Y block are stored:
(0, 1, 2, 3, 6, 7, 8, 9).
   Again, the skipped locations are reserved for U and V samples. FIG. 9b shows the columns where the first 2 samples from the first U block are stored:
(4, 10).
   And FIG. 9c shows the columns where the first 2 samples from the first V block are stored:
(5, 11).
   In this example, eight pixels may be fetched in three read operations, as pixels P₀ , P₁, P₂, P₃, P₄, P₅, P₆, P₇ are defined, respectively, by {Y₀, U₀, V₀}, {Y₁, U₀, V₀}, {Y₂, U₀, V₀}, {Y₃, U₀, V₀}, {Y₄, U₄, V₄}, {Y₅, U₄, V₄}, {Y₆, U₄, V₄}, and {Y₇, U₄, V₄}.

Referring again to FIG. 7, the sample arranger 48 is coupled to the CODEC 28 by way of address bus 18 and to the line buffer 30 by way of address bus 19. The CODEC 28 sends data to the memory 29 via bus 16 and preferably specifies the address where the data is to be stored on bus 18. But it is not critical that the CODEC specify an address on bus 18 so long as the sample arranger receives a signal of some type each time the CODEC presents a sample to the memory. For instance, the sample arranger 48 may detect that the CODEC has presented a sample by detecting that an address has been placed on bus 18, that new data has been placed on bus 16, by detecting a signal, such as a write signal, or in some other manner. In alternative embodiments, to enable the sample arranger 48 to be able to detect that a sample has been presented, it is appropriately coupled to data bus 16 or a signal line.

FIG. 10 shows one preferred embodiment of the sample arranger 48. This embodiment is adapted for 4:2:2 block-interleaved image data. The sample arranger 48 has a sample detector 69 and a logic circuit 70. The output of the sample detector 69, a signal NSMP, is input to logic circuit 70. And the output of the logic circuit is input to an 8-bit adder 72. This output is a signal, INC, which is also a binary number. The logic circuit 70 also has an output for generating a RESET signal that is input to register 74.

The 8-bit adder 72 has two inputs and one output. The INC signal is placed on one input and the previous output of the adder 72 is placed on the other input. The output of the adder 72 is the sum of the binary numbers on its inputs and this sum, which is stored register 74, is fed back to one input of the adder 72. Each time a sample is presented to the line buffer 30, the sample detector 69 asserts NSMP, the logic circuit 70 outputs a new INC signal, and the adder 72 adds the INC signal to its previous output. The output of the adder 72 and register 74 is an offset parameter for the sample, which is provided to a second adder 75.

The adder 75 sums a base address and the offset parameter and outputs an address that is presented via bus 19 to line buffer 30. The base address specifies where the image data is to be stored in memory 29. For example, the base address may be the first address in the memory 29 set aside for the line buffer 30. As another example, the base address may be the first address in either the first or second half of the line buffer 30.

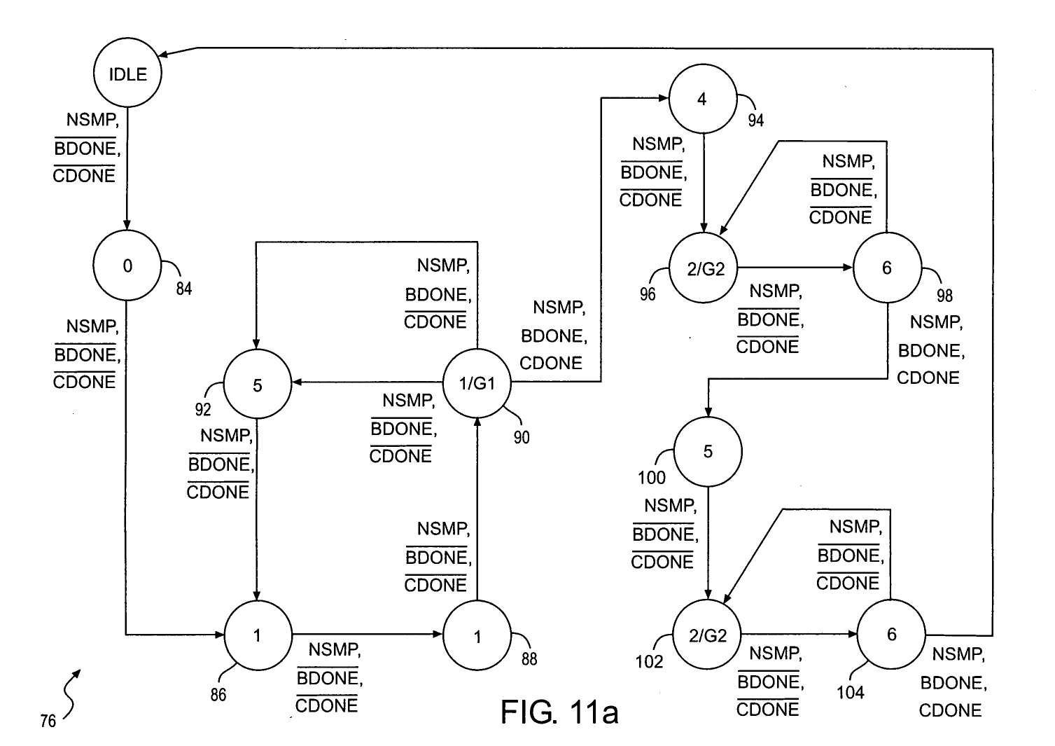

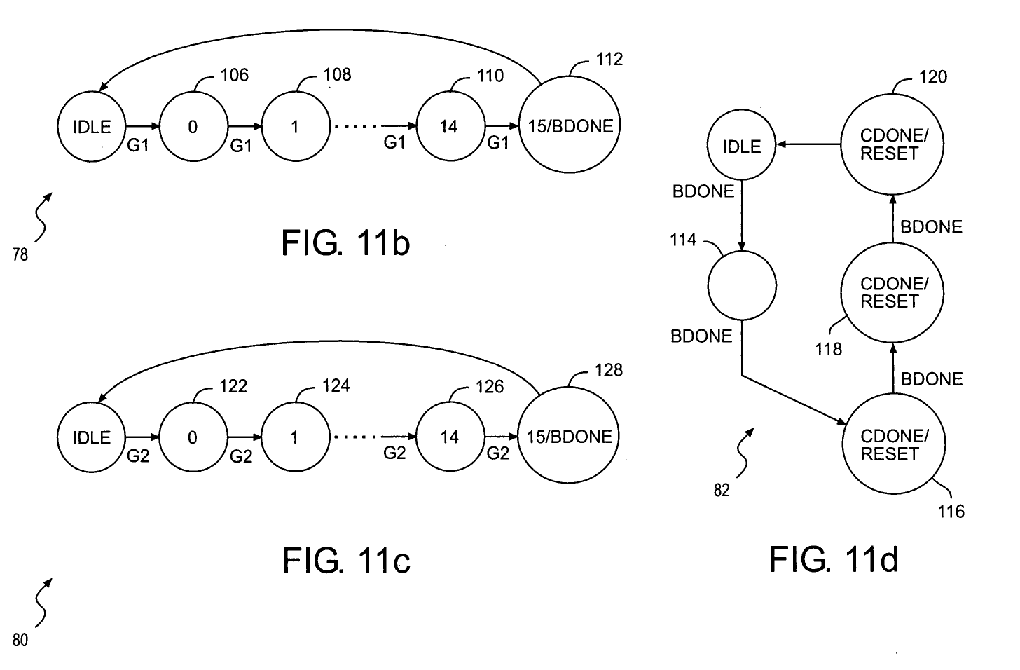

The logic circuit 70 may be constructed according to traditional design methods using a plurality of simple logic gates. The operation of logic circuit 72 may be defined by one or more state machines. FIGS. 11a-d show one exemplary set of state machines for defining the operation of logic circuit 70.

Signals

When NSMP is asserted, it means the CODEC has presented a new sample to the line buffer. When the signal BDONE is asserted, it means the CODEC has sent the last sample in a block of components. When the signal CDONE is asserted, it means the CODEC has sent the last component sample of any particular type. For example, for 4:2:2 data, the CODEC sends blocks: Y₀, Y₁, U₀, V₀. BDONE is asserted when the CODEC sends the last sample in the first component block Y₀. BDONE is again asserted, along with CDONE, when the CODEC sends the last sample in block Y₁, signaling that the last sample in the block and the last sample of the Y type component type. Both the CDONE and BDONE are asserted when the CODEC sends the last sample in the U₀ block. And when the CODEC sends the last sample in the V₀ component block, CDONE and BDONE are again asserted.

When the signals G1 and G2 are asserted, it means a group is complete. Referring again to FIGS. 2a-c, groups G of four consecutive samples are shown to illustrate the meaning of sampling format. The groups G are also used, in this embodiment, when reconstructing pixels. As shown in FIGS. 3b, Y, U, and V groups of components are created when samples are selected from the four pixels of FIG. 3a using the 4:2:2 sampling format. The groups of FIG. 3b correspond to the groups G in FIGS. 2a and 2b. If the signal G1 or G2 is asserted, it means the CODEC sends the last sample in a group G. If the sample is in a group of Y components, G1 is asserted. If the last sample is in a group of U or V components, G2 is asserted.

The signal RESET is asserted when the register 74 needs to be reset to zero. In one alternative embodiment, the signal NSMP is generated by the CODEC. In a preferred embodiment, all of the above described signals except NSMP are generated by the logic circuit 70.

State Machines

FIGS. 11a-d show respectively state machines 76, 78, 80, and 82.

One principle that underlies the sample arranger 48 (and hence the state machines) is that the sequential position of a sample within the minimum coded unit implicitly identifies the sample. For example, consider 4:2:2 block-interleaved data. The sample in the first sequential position of the MCU is the first sample in the Y₀ block. The sample in the 65^{th} sequential position is the first sample in the Y₁ block. The sample in the 129^{th} sequential position is the first sample in the U₀ block. And the sample in the 193^{rd} sequential position of the MCU is the first sample in the V₀ block.

Generally, the state machines are illustrated using several conventions. The signal or signals that are asserted when the logic circuit enters (or is in) a particular state appear(s) within the circle representing the state. State machines 78 and 80 are exceptions, however, as the number appearing in state circles is simply the sequential number of the state. The ellipses in state machines 78 and 80 indicate that these state machines each have a total of 16 states (plus an IDLE state). An arrow indicates a transition to another state. When the signals shown at the tail of an arrow are asserted, the logic circuit 70 transitions to the state pointed to. A bar over a signal indicates that the signal is asserted when low.

State Machine 76

The state machine 76 generates the INC signal. The signal NSMP is asserted each time the CODEC presents a new sample to the memory. And each time NSMP is asserted the state machine 76 transitions to a new state where a new INC signal is produced (by the logic circuit 70). In every state except IDLE, an INC signal is produced. Thus the state machine 76 associates an INC value with every sample in a MCU. In addition, the state machine 76 produces signals G1 and G2 in states 90, 96, and 102, indicating that the CODEC has sent the last sample in a group G. These signals G1 and G2 trigger transitions in state machines 78 and 80.

The state machine 76 uses particular states exclusively for producing the INC values for particular types of components. The state machine 76 produces values of INC for Y components when it is in states 84, 86, 88, 90, and 92. Similarly, the state machine 76 produces values of INC for U components when it is in states 94, 96, and 98. Further, the state machine 76 produces values of INC for V components when it is in states 100, 102, and 104.

State Machine 78

The signal G1 triggers transitions in state machine 78. When state machine 76 produces the G1 signal, it means the CODEC has finished sending a group of Y samples. When state machine 76 produces the G1 signal, the state machine 78 transitions to the next sequential state. The state machine 78 has one state for each group in a block of Y components. As the state machine 78 transitions from IDLE to state 15, it effectively counts all of the groups in Y component block. The state machine 78 produces a BDONE signal in state 15, indicating that the CODEC has sent the last sample in a block of Y components.

State Machine 80

The signal G2 triggers transitions in state machine 80. When state machine 76 produces the G2 signal, it means the CODEC has finished sending a group of U or V samples. When state machine 76 produces the G2 signal, the state machine 80 transitions to the next sequential state. The state machine 80 has one state for each group in a block of U or V components. As the state machine 80 transitions from IDLE to state 15, it effectively counts all of the groups in a U or V component block. The state machine 80 produces a BDONE signal in state 15, indicating that the CODEC has sent the last sample in a block of U or V components.

State Machine 82

The signal BDONE triggers transitions in state machine 82. The signal BDONE is produced by state machines 78 and 80. When either state machine produces the BDONE signal, it means the CODEC has finished sending a block of samples. When either state machine produces the BDONE signal, the state machine 82 transitions to the next sequential state. The state machine 82 has one state for each block in a 4:2:2 MCU. As the state machine 82 transitions from IDLE to state 120, it effectively counts all of the blocks in a MCU. The state machine 82 produces a CDONE and RESET signals in state 116, 118, and 120 indicating that the CODEC has sent the last sample of a particular type of component.

The state machine 76 uses particular states exclusively for producing the INC values for particular types of components. When state machine 82 produces the CDONE signal, the state machine 76 transitions to the next set of particular states for producing the INC values for a particular type of component. For example, the state machine 76 uses the states 84, 86, 88, 90, and 82 to produce the INC values for Y type of components. And the state machine 76 uses the states 94, 96, 98 to produce the INC values for U type of components. When state machine 82 produces the CDONE signal in state 116, the state machine 76 transitions from state 90 (Y component) to state 94 (U component). In addition, the register 74 needs to be reset at this time and the state machine 82 produces the RESET signal.

Component Block Y₀

Initially, all of the state machines are in the IDLE state and the counter 74 holds a zero. When the CODEC sends the first sample in an MCU, NSMP is asserted and state machine 76 (FIG. 11a) transitions to state 84. The logic circuit 70 outputs a zero for signal INC. The adder 72 sums INC and the value stored in register 74 and outputs, as a first offset parameter, a zero (0). The state machine 76 transitions to state 86 when the CODEC sends the next sample. The logic circuit 70 outputs a one. The adder 72 outputs, as a second offset, a one (1). The state machine 76 transitions to state 88 when the CODEC sends the next sample and the logic circuit 70 outputs a one. The adder 72 outputs, as a third offset, the sum of one and one (2). The state machine 76 transitions to state 90 when the CODEC sends the next sample. The logic circuit 70 outputs a one and asserts the G1 signal. The adder 72 outputs, as a fourth offset, the sum of one and two (3). To summarize, the sample arranger 48 outputs (assuming a base address of zero) addresses 0, 1, 2, and 3 for the first four samples generated by the CODEC. The G1 signal causes state machine 78 (FIG. 8b) to transition from idle to state 106.

When the CODEC sends the fifth sample, the state machine 76 transitions to state 92 and outputs a five. The adder 72 outputs, as a fourth offset parameter, the sum of three and five (8). As the CODEC sends the sixth, seventh, and eighth samples, the state machine 76 transitions to states 86, 88, and 90, and the adder outputs offsets 9, 10, and 11. Upon receipt of the eighth sample, the logic circuit 70 again asserts the G1 signal causing state machine 78 to transition from state 106 to state 108. To summarize, the sample arranger 48 outputs (assuming a base address of zero) addresses 8, 9, 10, and 11 for the second group of four samples generated by the CODEC. Thus the sample arranger 48 outputs four sequential addresses (0, 1, 2, 3), skips the next four sequential addresses (4, 5, 6, 7), and then outputs four sequential addresses (8, 9, 10, 11).

When the CODEC sends the 64^{th} sample and the state machine 76 enters state 90 where G1 is produced. The G1 signal causes the state machine 78 to transition to state 112. The logic circuit 70 generates the signal BDONE, indicating that the CODEC is done sending a block. The BDONE signal causes the state machine 82 (FIG. 8d) to transition from idle to the state 114. In this case, the CODEC is done sending the first component block Y₀.

Component Block Y₁

The process described above for the Y₀ block is repeated for the next 64 samples generated by the CODEC. The logic circuit 70 outputs increasing addresses in the above-described pattern. When the CODEC sends the 128^{th} sample, the state machine 76 enters state 90 and G1 is generated causing state machine 78 to enter state 112 where BDONE is generated. Because BDONE is asserted, state machine 82 enters state 116, where the logic circuit produces the CDONE and RESET signals. BDONE indicates that the CODEC is done sending the Y, block. The signal CDONE indicates that the CODEC is done sending all the samples of the Y type component.

Component Block U₀

When the CODEC sends the 129^{th} sample, the state machine 76 transitions to state 94. The logic circuit 70 outputs a four. The adder 72 sums the values on its inputs and outputs a four (4). This is the first offset parameter for the first sample in the U₀ block. The state machine 76 transitions to state 96 when the CODEC sends the next sample. The logic circuit 70 outputs a two and the signal G2. The adder 72 sums INC and the value stored in register 74 and outputs, as a second U offset, (2+4 =6). When the CODEC sends the next sample, the state machine 76 transitions to state 98. The logic circuit 70 outputs a six. The adder 72 outputs, as a third offset, the sum of six and six (12). The state machine 76 transitions to state 96 when the CODEC sends another sample. The logic circuit 70 outputs a two and the signal G2. The adder 72 outputs, as a fourth U offset, (2+12=14). To summarize, the first, second, third, and fourth addresses for the U samples are 4, 6, 12, and 14. Thus the logic circuit 70 sequentially outputs (assuming a base address of zero) an address (4), skips an address (5), outputs an address (6), skips five addresses (7, 8, 9, 10, 11), outputs an address (12), skips an address (13), and outputs an address (14).

Component Block V₀

When the CODEC sends the 193^{rd} sample, the state machine 76 transitions to state 100. With each V sample the CODEC sends, the state machine 76 cycles through states 102 and 104 in a manner analogous to the U₀ block described above. The adder 72 outputs as first, second, third, and fourth offsets 5, 7, 13, and 15. This is the same pattern as with the U₀ samples, except the offset parameters are increased by one.

When the CODEC sends the last sample in the V₀ block, addresses have been generated for each sample in the MCU. The state machines return to the IDLE states where they stand ready to handle the next MCU. If the CODEC indicates that it will be sending a subsequent MCU, the sample arranger operates in a manner identical to that which has been described with one exception. Preferably, the base address is changed so that the second MCU does not overwrite the first MCU until the dimensional transform circuit has had a chance to read it. For example, a base address which causes the addresses to be specified in the second half of the line buffer may be provided if the first MCU was stored in the first half of the line buffer. The base addresses may alternate with each MCU in order to reuse memory once the dimensional transform circuit has read it.

The particular circuit and address generation method for implementing the invention is not critical. In one alternative embodiment, the CODEC 28 generates addresses that the sample arranger then translates into a new address. The new addresses generated as a result of the translation are the same or substantially the same as those described above. The important aspect is that new addresses provide for efficient reading from memory. As one skilled in the art will appreciate, addresses in conformity with the principles of the invention may be generated by a number of different circuits and methods.

To identify the sequential position of the transmitted samples, the sample arranger 48 must be provided with a signal indicating the start of an MCU. The sample arranger 48 is also provided with the sampling format. If the sampling format is variable, the sample arranger 48 may be provided with the sampling format with each MCU or series of MCUs. If the sampling format is fixed, it need only be provided to the sample arranger 48 once, such as when the system is initialized.

In the computer system 42, the dimensional transform circuit 46 (DT) differs from different dimensional transform circuit 32 in the way it fetches data from the line buffer 30. The dimensional transform circuit 32 fetches pixels by separately fetching three samples from each of three blocks stored in various parts of the line buffer 30. The dimensional transform circuit 32 generally must perform three read operations each time it fetches a single pixel. In contrast, the dimensional transform circuit 46 is capable of fetching one pixel in one read, four pixels in two reads, and 8 pixels in three reads for 4:4:4, 4:2:2, and 4:1:1 image data, respectively.

A person skilled in the art will also appreciate that the method for arranging samples in memory of the present invention may be embodied in software, firmware, or in any combination of hardware, software, or firmware. One preferred embodiment of the invention is the hardware implementation described above. In another preferred embodiment, a method incorporating the principles of the invention is embodied in a program of instructions that is stored on a machine-readable medium for execution by a machine to perform the method.

As mentioned, the preferred embodiment of the sample arranger described above pertains to arranging 4:2:2 image data. It is contemplated that the above embodiment may be modified to accommodate image data in which samples were selected using other sampling formats, such as 4:2:2, 4:1:1, and 4:2:0 without departing from the principles of the invention.

In FIGS. 9b-c, Y₀, Y₁, Y₂, Y₃, U₀, V₀, U₂, and V₂ are stored in sequential locations. This specific ordering, however, is not essential. In 8 sequential columns in the same row, there these samples may be ordered in 40,320 different ways (8! permutations). It is contemplated that the sample arranger may produce addresses in conformity with any of these permutations. Moreover, image data created according to other sampling formats may be ordered in 8 or 12 or some other number N of sequential columns in the same row. For each of the other sampling formats, there will be more than one permutation for ordering the samples in the N of sequential columns. It is contemplated that the sample arranger may be adapted to produce addresses for image data created according to any possible permutation that results with other sampling formats. As previously mentioned, what is important is that the samples be arranged in memory so that they may be efficiently read.

Generally speaking, reading samples from anywhere in the same row reduces the required number of clock cycles to fetch a pixel. Preferably the samples that define a particular group of pixels are stored in sequential columns so that all of the samples to assemble the pixels may be obtained in one or two or three read operations from consecutive locations (depending on the sampling format in which the data was created). In one alternative embodiment, however, the samples that define a particular pixel may be stored in any column in the row. In this embodiment, all of the samples to assemble the group of pixels may still be read in a minimum number of read operations, however, more MCLKs are required to perform read operations from non-sequential than sequential columns in the same row.

The invention has been illustrated with a CODEC generating samples in block-interleaved sequence and a dimensional transform circuit 46 reading pixels from a memory. However, neither the circuit creating the block-interleaved image data nor the one reading it from memory is critical to the invention. That is, the invention may be practiced with any device that generates samples in block-interleaved sequence or that needs to read samples from memory to assemble them into pixels. Moreover, while the invention has been described with respect to block-interleaved image data, it may be modified to accommodate data of other types arranged in other predetermined sequences.

The terms and expressions that have been employed in the foregoing specification are used as terms of description and not of limitation, and are not intended to exclude equivalents of the features shown and described or portions of them. The scope of the invention is defined and limited only by the claims that follow.

1. A method for specifying addresses in a memory for each sample in a minimum coded unit, the minimum coded unit defining a plurality of pixels, each pixel being defined by a plurality of sample components, and the samples being presented in a predetermined sequence to the memory for storage, wherein the memory has a plurality of memory locations, each memory location being defined by a column and a row, and each memory location having an address, the method comprising:
detecting the presentation to the memory of the samples that define a particular pixel;
providing an offset parameter for each of the samples whose presentation is detected, each offset parameter being based on the respective position of the sample within the predetermined sequence such that adding any of the respective offset parameters to a base address yields a respective address for a location in a particular row of the memory; and
storing said samples at each said respective address.

2. The method of claim 1, wherein the step of providing an offset parameter for each of the samples whose presentation is detected yields respective addresses such that the samples that define a first pixel can be read in one read operation.

3. The method of claim 2, further comprising reading from the memory the samples that define said first pixel in one read operation.

4. The method of claim 1, wherein the step of providing an offset parameter for each of the samples whose presentation is detected yields respective addresses such that the samples that define four pixels can be read in two read operations.

5. The method of claim 4, further comprising reading from the memory the samples that define said four pixels in two read operations.

6. The method of claim 1, wherein the step of providing an offset parameter for each of the samples whose presentation is detected yields respective addresses such that the samples that define eight pixels can be read in three read operations.

7. The method of claim 6, further comprising reading from the memory the samples that define said pixels in three read operations.

8. The method of claim 1, wherein each of the plurality of pixels is defined by a first, second, and third sample component, and the step of providing an offset parameter for each of the samples whose presentation is detected yields, for the samples that define a first pixel, respectively, a first, second, and third address.

9. The method of claim 8, wherein the first, second, and third addresses for the samples that define the first pixel are consecutive addresses.

10. The method of claim 8, wherein, for the samples that define the first pixel:
the first address is in the particular row of the memory;
the second address is separated from the first address by three addresses, and the third address is separated from the first address by four addresses and is consecutive to the second address.

11. The method of claim 10, wherein the step of providing an offset parameter for each of the samples whose presentation is detected further yields, for the samples that define a second pixel, a fourth address, and:
the fourth address is consecutive to the first address;
the second address is separated from the first address by three addresses and from the fourth address by two addresses; and
the third address is separated from the first address by four addresses and from the fourth address by three addresses.

12. The method of claim 11, wherein the step of providing an offset parameter for each of the samples whose presentation is detected further yields, for the samples that define a third pixel, a fifth address, and:
the fifth address is separated from the first address by one address;
the second address is separated from the first address by three addresses and from the from the fifth address by one address; and
the third address is separated from the first address by four addresses and from the fifth address by two addresses.

13. The method of claim 1, wherein the base address is the first address in the memory.

14. The method of claim 13, wherein the memory is partitioned into a first and second half and the base address is the first address in the second half of the memory.

15. A machine-readable medium embodying a program of instructions for execution by a machine to perform a method for specifying addresses in a memory for each sample in a minimum coded unit, the minimum coded unit defining a plurality of pixels, each pixel being defined by a plurality of sample components, and the samples being presented in a predetermined sequence to the memory for storage, wherein the memory has a plurality of memory locations, each memory location being defined by a column and a row, and each memory location having an address, the method comprising:
detecting the presentation to the memory of the samples that define a particular pixel;
providing an offset parameter for each of the samples whose presentation is detected, each offset parameter being based on the respective position of the sample within the predetermined sequence such that adding any of the respective offset parameters to a base address yields a respective address for a location in a particular row of the memory; and
storing said samples at each said respective address.

16. The method of claim 15, wherein the step of providing an offset parameter for each of the samples whose presentation is detected yields respective addresses such that the samples that define a first pixel can be read in one read operation.

17. The method of claim 16, further comprising reading from the memory the samples that define the first pixel in one read operation.

18. The method of claim 15, wherein the step of providing an offset parameter for each of the samples whose presentation is detected yields respective addresses such that the samples that define four pixels that can be read in two read operations.

19. The method of claim 18, further comprising reading from the memory the samples that define said four pixels in two read operations.

20. The method of claim 15, wherein the step of providing an offset parameter for each of the samples whose presentation is detected yields respective addresses such that the samples that define eight pixels that can be read in three read operations.

21. The method of claim 18, further comprising reading from the memory the samples that define said eight pixels in three read operations.

22. The method of claim 15, wherein each of the plurality of pixels is defined by a first, second, and third sample component, and the step of providing an offset parameter for each of the samples whose presentation is detected yields, for the samples that define a first pixel, respectively, a first, second, and third address.

23. The method of claim 22, wherein the first, second, and third addresses for the samples that define the first pixel are consecutive addresses.

24. The method of claim 22, wherein, for the samples that define the first pixel:
the first address is in the particular row of the memory;
the second address is separated from the first address by three addresses, and
the third address is separated from the first address by four addresses and is consecutive to the second address.

25. The method of claim 24, wherein the step of providing an offset parameter for each of the samples whose presentation is detected further yields, for the samples that define a second pixel, a fourth address, and:
the fourth address is consecutive to the first address;
the second address is separated from the first address by three addresses and from the fourth address by two addresses; and
the third address is separated from the first address by four addresses and from the fourth address by three addresses.

26. The method of claim 25, wherein the step of providing an offset parameter for each of the samples whose presentation is detected further yields, for the samples that define a third pixel, a fifth address, and:
the fifth address is separated from the first address by one address;
the second address is separated from the first address by three addresses and from the from the fifth address by one address; and
the third address is separated from the first address by four addresses and from the fifth address by two addresses.

27. The method of claim 15, wherein the base address is the first address in the memory.

28. The method of claim 27, wherein the memory is partitioned into a first and second half and the base address is the first address in the second half of the memory.

29. An apparatus for specifying addresses in a memory for each sample in a minimum coded unit, the minimum coded unit defining a plurality of pixels, each pixel being defined by a plurality of sample components, and the samples being presented in a predetermined sequence to the memory for storage, wherein the memory has a plurality of memory locations, each memory location being defined by a column and a row, and each memory location having an address, the apparatus comprising:
a detector for detecting the presentation to the memory of the samples that define a particular pixel;
a sample arranger for:
providing an offset parameter for each of the samples whose presentation is detected, each offset parameter being based on the respective position of the sample within the predetermined sequence such that adding any of the respective offset parameters to a base address yields a respective address for a location in a particular row of the memory; and
adding each said offset parameter to the base address to generate said respective address for storing said samples.

30. The apparatus of claim 29, wherein the sample arranger is adapted to provide addresses for the samples that define a first pixel such that the samples can be read in one read operation.

31. The apparatus of claim 30, further comprising a dimensional transform circuit adapted to read from the memory the samples that define the first pixel in one read operation.

32. The apparatus of claim 29, wherein the sample arranger is adapted to provide addresses for the samples that define four pixels such that the samples can be read in two read operations.

33. The apparatus of claim 32, further comprising a dimensional transform circuit adapted to read from the memory the samples that define said four pixels in two read operations.

34. The apparatus of claim 29, wherein the sample arranger is adapted to provide addresses for the samples that define eight pixels such that the samples can be read in three read operations.

35. The apparatus of claim 34, further comprising a dimensional transform circuit adapted to read from the memory the samples that define said eight pixels in three read operations.

36. The apparatus of claim 29, wherein each of the plurality of pixels is defined by a first, second, and third sample component, and for the samples that define a first pixel, the sample arranger is adapted to provide, respectively, a first, second, and third address.

37. The apparatus of claim 36, wherein the sample arranger is adapted to provide first, second, and third addresses for the samples that define the first pixel that are consecutive addresses.

38. The apparatus of claim 36, wherein, for the samples that define the first pixel, the sample arranger is adapted to provide respective addresses such that:
the first address is in the particular row of the memory;
the second address is separated from the first address by three addresses, and
the third address is separated from the first address by four addresses and is consecutive to the second address.

39. The apparatus of claim 38, wherein, for the samples that define a second pixel, the sample arranger is adapted to provide a respective addresses such that, and:
a fourth address is consecutive to the first address;
the second address is separated from the first address by three addresses and from the fourth address by two addresses; and
the third address is separated from the first address by four addresses and from the fourth address by three addresses.

40. The apparatus of claim 39, wherein, for the samples that define a third pixel, the sample arranger is adapted to provide a respective addresses such that:
a fifth address is separated from the first address by one address;
the second address is separated from the first address by three addresses and from the from the fifth address by one address; and
the third address is separated from the first address by four addresses and from the fifth address by two addresses.

41. The apparatus of claim 29, wherein the base address is the first address in the memory.

42. The apparatus of claim 41, wherein the memory is partitioned into a first and second half and the base address is the first address in the second half of the memory.

43. An computer system for specifying addresses in a memory for each sample in a minimum coded unit, the minimum coded unit defining a plurality of pixels, each pixel being defined by a plurality of sample components, and the samples being presented in a predetermined sequence to the memory for storage, wherein the memory has a plurality of memory locations, each memory location being defined by a column and a row, and each memory location having an address, the computer system comprising:
a central processing unit;
a display device; and
a graphics controller, comprising:
a memory:
a detector for detecting the presentation to the memory of the samples that define a particular pixel; and
a sample arranger for:
providing an offset parameter for each of the samples whose presentation is detected, each offset parameter being based on the respective position of the sample within the predetermined sequence such that adding any of the respective offset parameters to a base address yields a respective address for a location in a particular row of the memory; and
adding each said offset parameter to the base address to generate said respective address for storing said samples.

44. The computer system of claim 43, wherein the sample arranger is adapted to provide addresses for the samples that define a first pixel such that the samples can be read in one read operation.

45. The computer system of claim 44, further comprising a dimensional transform circuit adapted to read from the memory the samples that define the first pixel in one read operation.

46. The computer system of claim 43, wherein the sample arranger is adapted to provide addresses for the samples that define four pixels such that the samples can be read in two read operations.

47. The computer system of claim 46, further comprising a dimensional transform circuit adapted to read from the memory the samples that define said four pixels in two read operations.

48. The computer system of claim 43, wherein the sample arranger is adapted to provide addresses for the samples that define eight pixels such that the samples can be read in three read operations.

49. The computer system of claim 48, further comprising a dimensional transform circuit adapted to read from the memory the samples that define said eight pixels in three read operations.

50. The computer system of claim 43, wherein each of the plurality of pixels is defined by a first, second, and third sample component, and for the samples that define a first pixel, the sample arranger is adapted to provide, respectively, a first, second, and third address.

51. The computer system of claim 50, wherein the sample arranger is adapted to provide first, second, and third addresses for the samples that define the first pixel that are consecutive addresses.

52. The computer system of claim 50, wherein, for the samples that define the first pixel, the sample arranger is adapted to provide respective addresses such that:
the first address is in the particular row of the memory;
the second address is separated from the first address by three addresses, and
the third address is separated from the first address by four addresses and is consecutive to the second address.

53. The computer system of claim 52, wherein, for the samples that define a second pixel, the sample arranger is adapted to provide a respective addresses such that, and:
a fourth address is consecutive to the first address;
the second address is separated from the first address by three addresses and from the fourth address by two addresses; and
the third address is separated from the first address by four addresses and from the fourth address by three addresses.

54. The computer system of claim 53, wherein, for the samples that define a third pixel, the sample arranger is adapted to provide a respective addresses such that:
a fifth address is separated from the first address by one address;
the second address is separated from the first address by three addresses and from the from the fifth address by one address; and
the third address is separated from the first address by four addresses and from the fifth address by two addresses.

55. The computer system of claim 43, wherein the base address is the first address in the memory.

56. The computer system of claim 55, wherein the memory is partitioned into a first and second half and the base address is the first address in the second half of the memory.
